(19) United States
(12) Patent Application Publication
(10) Pub. No.: US 2008/0295659 A1
(43) Pub. Date: Dec. 4, 2008

(54) Method of Aligning and Cutting Web of Lidstock

(76) Inventors: Patrick Joseph Tobin, Waterford (IE); Trevor O'Neill, Waterford (IE); Michael Murphy, Waterford (IE)

Correspondence Address: Bausch & Lomb Incorporated, One Bausch & Lomb Place, Rochester, NY, 14604-2701, US

(21) Appl. No.: 12/159,256

(22) PCT Filed: Jan. 12, 2007
(86) PCT No.: PCT/EP2007/000372

§ 371 Date: Jun. 26, 2008

(30) Foreign Application Priority Data
Jan. 16, 2006 (GB) 0600851.0

(51) Int. Cl. B26D 5/34

(52) U.S. Cl. 83/13; 83/73; 83/209

(57) ABSTRACT

A method for cutting lidstock units from a web of pre-printed lidstock, the steps of: a) providing a web of pre-printed lidstock comprising a plurality of lidstock units across its width and its length and provided with a plurality of registration marks, b) feeding the web in the direction of its length through a cutting region provided with a first and a second optical sensor, c) stopping the feeding of the web when the first optical sensor detects a registration mark, d) moving the web in the direction of its width until a second optical sensor detects the registration mark, e) cutting the web in the cutting region into lidstock units by means of cutters.

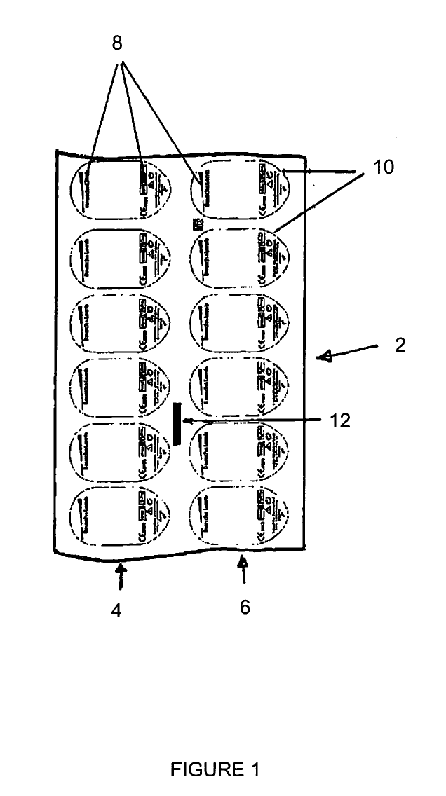

The invention relates to a method for aligning and cutting pre-printed lidstock web to form lidstock units for sealing blister packages, particularly blister packages for disposable contact lenses.

Soft hydrogel contact lenses have been increasing in popularity ever since they were first introduced in the 1970's. Such contact lenses are conventionally packaged in the hydrated state and in a storage solution. Currently, many contact lenses are packaged, along with the aqueous storage solution, in a disposable blister package typically formed from container of a rigid polymer sealed with a lidstock. Examples of blister packages can be seen in U.S. Pat. Nos. 4,691,820; 5,524,419; 5,578,331, 5,649,410, 5,722,536 and 6,082,533. The container forming the base of a blister package can either be part of the original contact lens mold or a separately molded base, typically formed from a rigid polymer. In the above mentioned package types, the container that holds the contact lens and any aqueous storage solution, is sealed by a flexible lidstock. This lidstock is typically a laminated foil which can be pulled back by a user to access the lens contained in the blister of the container. Typically, this lidstock is sealed to the area or flange of the top surface of the container surrounding the blister.

Such lidstock is generally pre-printed with information concerning the lenses contained within the blister package. It is desirable to provide the lidstock unit directly to the surface of the blister package to be sealed at a location or station in a packaging line assembly adjacent or close to where the blister has been filled with contact lens and/or hydrating solution. Such rapid sealing helps to ensure minimal contamination of the contents by extraneous matter.

In order to ensure that each blister pack is provided with the entire information needed, and to ensure an attractive appearance, accurate cutting of lidstock units from the lidstock web is necessary. A lidstock unit is a piece of lidstock of the correct size to use for sealing a blister pack.

Until now, a cutting method such as disclosed in U.S. Pat. No. 3,713,571 may have been used with strips of lidstock (i.e. a strip of lidstock which is one lidstock in width, and where cuts are made across the strip to divide the strip into lidstock units).

However it is desirable to use large rolls of lidstock material in web form which comprises many lidstock units across its width as well as its length.

EP 1225535 discloses a method in which a transported material web provided with structured images, e.g. printed images, embossed images and perforation images via successive processing steps, overlaid by a cut image is divides the material web into partial webs, in a final processing step. A velocity-regulated laser beam is directed onto the material web, a detectable laser line provided by material removal or a material thickness variation, with laser markings provided along the laser line by varying the laser radiation duration or power level, used for providing signals controlling the next processing step.

According to the invention there is provided a method for cutting lidstock units from a web of pre-printed lidstock the steps of:

a) providing a web of pre-printed lidstock comprising a plurality of lidstock units across its width and its length and provided with a plurality of registration marks,
b) feeding the web in the direction of its length through a cutting region provided with a first and a second optical sensor,
c) stopping the feeding of the web when the first optical sensor detects a registration mark,
d) moving the web in the direction of its width until a second optical sensor detects the registration mark,
e) cutting the web in the cutting region into a plurality lidstock units by means of cutters.

The accurate positioning of the web and its pre-printed lidstock units is assured by the positioning of the web with respect to the cutting surface by means of the positional information derived from the registration marks by the first and second optical sensors.

This gives the advantages that the lidstock roll only needs to be changed at infrequent intervals, as many more lidstock units can be provided on a wide roll as compared to a strip. Further, for a multiple line manufacturing and/or packaging assembly, where several manufacturing and/or packaging lines are operating in parallel, the lidstock can be supplied to the multiple parallel stations more rapidly from a wide web comprising several lidstock units across its width.

After the lidstock units have been cut from the web using the method, they may be picked and placed, for instance with a vacuum head, onto the top surfaces of blister packages in order to seal the packages.

The lidstock material is suitably a metal laminate foil comprising a metal foil layer such as aluminium or an alloy comprising aluminum. The basal layer of the lidstock, which is used for forming a hermetic seal on the blister pack, is suitably a thermoplastic polymer such as polypropylene.

The lidstock is pre-printed on the upper surface with the label information for the blister pack in addition to registration marks which are detectable by the first and second optical sensors. Printing the registration marks with the label information ensures the registration marks will always be in the same position relative to the label information regardless of the position of the printing relative to the edge of the web and therefore the web can be positioned using the registration marks so that the cutters are positioned correctly over the information. The registration marks will be marks which can be discriminated from the labeling by the optical sensors and may for instance be of a special shape or colour such that an image analysis system connected to the optical sensors can discriminate the registration marks. Alternatively, the registration marks may be highly reflective or highly non reflective such that a change in intensity of light detected by the optical sensors mat be used to discriminate the registration marks. Suitable optical sensors are fibre optic sensors. The registration marks are spaced along the length of the web with a frequency corresponding to that of the uncut lidstock units on the pre-printed foil.

The pre-printed lidstock is suitably stored on a cylindrical roller, with its width along the axis of the roller and its length tangential to the roller.

The cutting out of the lidstock units may be performed by any suitable means, but is preferably carried out by a punching means, in which case the cutting region will have cutters in the form of a punching means suitable for punching out a plurality of lidstock units, preferably simultaneously. For example, the punching means can conveniently simultaneously punch out two or more rows of lidstock units, each row extending across the web.

The feeding of the web through the cutting region is suitably achieved by means of feed rollers driven by servo motors on the opposite side of the cutting region to the roll of preprinted lidstock web. Such feeding and tensioning systems are known in the art. The movement of the web in the direction of its width (i.e. parallel to the axis of the roll of preprinted web) may be achieved by means of moveable supports driven by servo motors for the roll of web and for the feed rollers.

The invention will be described with reference to the accompanying drawing which illustrates a web of pre-printed lidstock suitable for use in the invention.

The web general shown at 2 comprises 2 rows (4, 6) of lidstock units extending along the length of the web. Each lidstock unit comprises printed information (8). The cut profile (10) for each lidstock is shown for clarity but this need not be printed on the web.

In accordance with the invention the web comprises a registration mark which is detected by the first and second sensor to enable the web to be accurately positioned in the longitudinal and transverse directions prior to punching out the lidstock units, e.g. 10 units at a time. The web comprises a plurality of registration marks at appropriate positions along the web.

Preferably, the station for use of the method of the invention is adjacent or close to or forms part of a manufacturing and/or packaging assembly line for the blister packages. A suitable manufacturing and packaging assembly line is described in WO 2004/056555.

1. A method for cutting lidstock units for sealing blister packages from a web of pre-printed lidstock, the steps of:
a) providing a web of pre-printed lidstock comprising a plurality of lidstock units across its width and its length and provided with a plurality of registration marks,
b) feeding the web in the direction of its length through a cutting region provided with a first and a second optical sensor,
c) stopping the feeding of the web when the first optical sensor detects a registration mark,
d) moving the web in the direction of its width until a second optical sensor detects the registration mark,
e) cutting the web in the cutting region into lidstock units by means of cutters.

2. A method according to claim 1 wherein the optical sensor is a fibre optic sensor.

3. A method according to claim 1 wherein the cutters are a punching means.

4. A method according to claim 1 wherein the registration marks are printed simultaneously with the printing to form the pre-printed lidstock.

5. A method according to claim 1 in which a plurality of lidstock units are cut simultaneously by means of cutters.

6. A method according to claim 5 in which two or more rows of lidstock units are cut simultaneously by means of cutters, the rows of lidstock units extending across the web.

7. A method according to claim 2 wherein the cutters are a punching means.
